(19) United States
(12) Patent Application Publication
(10) Pub. No.: US 2008/0271593 A1
(43) Pub. Date: Nov. 6, 2008

(54) Data converting device

(75) Inventors: Akio TAKAHASHI, Hamamatsu-shi (JP); Yoshikazu HONJI, Hamamatsu-shi (JP); Kiyoto KUROIWA, Hamamatsu-shi (JP)

Correspondence Address: PILLSBURY WINTHROP SHAW PITTMAN LLP, P.O BOX 10500, McLean, VA, 22102, US

(73) Assignee: Yamaha Corporation, Hamamatsu-shi (JP)

(21) Appl. No.: 11/974,542

(22) Filed: Oct. 15, 2007

(30) Foreign Application Priority Data
Oct. 13, 2006 (JP) 2006-279833

(51) Int. Cl. G10H 7/00

(52) U.S. Cl. 84/645

(57) ABSTRACT

A data converting device includes a first receiving section which receives vehicle driving data of a vehicle from an engine control unit for performing driving control of an engine mounted on the vehicle, and a control section which converts the vehicle driving data into a music performance format, and outputs the converted data.

### BACKGROUND

The present invention relates to a technique for collecting vehicle driving information indicating a traveling vehicle state such as a traveling speed and an engine rotation speed and a driving state such as an accelerator stepping amount of an automotive vehicle on which an engine is mounted.

A device has been proposed that acquires vehicle driving Information such as a traveling speed, an engine rotation speed and an accelerator stepping amount of an automotive vehicle such as an automobile on which an engine is mounted from an engine control unit (ECU) via a vehicle-mounted LAN (Local Area Network) and records the Information as a log indicating the chronological change in the vehicle state and the driving state (for example, refer to Non-patent Reference 1).

[Non-patent Reference 1] Internet, URL <http://www.iti.iwatsu.co.jp/>

If the above vehicle driving Information may be transmitted to a car navigation device or a car audio system, it is made possible to perform attentive route guidance in consideration of the travel speed or to reproduce a sound based on the travel speed, the engine rotation speed or the accelerator stepping amount, thereby enhancing the convenience and fun in cruising.

However, data collected and recorded by the device disclosed in Non-patent Reference 1 generally has a data format which is specifically defined by the manufacturer of a vehicle or the like. Thus, it is not easy to use such data for other car-mounted electronic devices such as a car navigation device and a car audio system.

### SUMMARY

The invention has been accomplished In view of the above problems. An object of the invention is to provide a technique that makes available to use the vehicle driving Information collected by an automotive vehicle having an engine in various types of electronic devices.

In order to solve the problems, the invention provides a data converting device, comprising:

a first receiving section which receives vehicle driving data of a vehicle from an engine control unit for performing driving control of an engine mounted on the vehicle; and

a control section which converts the vehicle driving data into a music performance format, and outputs the converted data.

Preferably, the vehicle driving data includes at least one of vehicle speed data, rotation speed data and accelerator opening data. The vehicle speed data represents a travel speed of the vehicle. The rotation speed data represents a rotation speed of the engine. The accelerator opening data represents a stepping amount of an accelerator plate for instructing an increase/decrease in the travel speed.

Preferably, The music performance format is a MIDI (Musical Instrument Digital Interface) format. The control section converts the vehicle driving data into the MIDI format in which a control change number corresponding to the type of the vehicle driving data is assigned.

Preferably, the data converting device further includes a second receiving section which receives sound data. The control section process the sound data with the converted data in the MIDI format, and outputs the processed data.

Preferably, the sound data is MIDI format data. The control section mixes the MIDI format data and the converted data in the MIDI format, and outputs the mixed data.

With such a data converting device, the data received by the first receiving section from the engine control unit is assigned a control change number corresponding to the type of the data and converted to data in MIDI format and then outputted.

According to the invention, vehicle driving information outputted from the ECU is converted into music performance format, especially the MIDI format as a de facto standard in music communications, so that it is made possible to use the vehicle driving information on various types of electronic devices.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a block diagram showing a configuration example of a data converting device according to an embodiment of the Invention;

FIG. 2 illustrates a MIDI format; and

FIG. 3 explains the assignment of control numbers according to the embodiment.

### DETAILED DESCRIPTION OF EXEMPLARY EMBODIMENTS

### (A: Configuration)

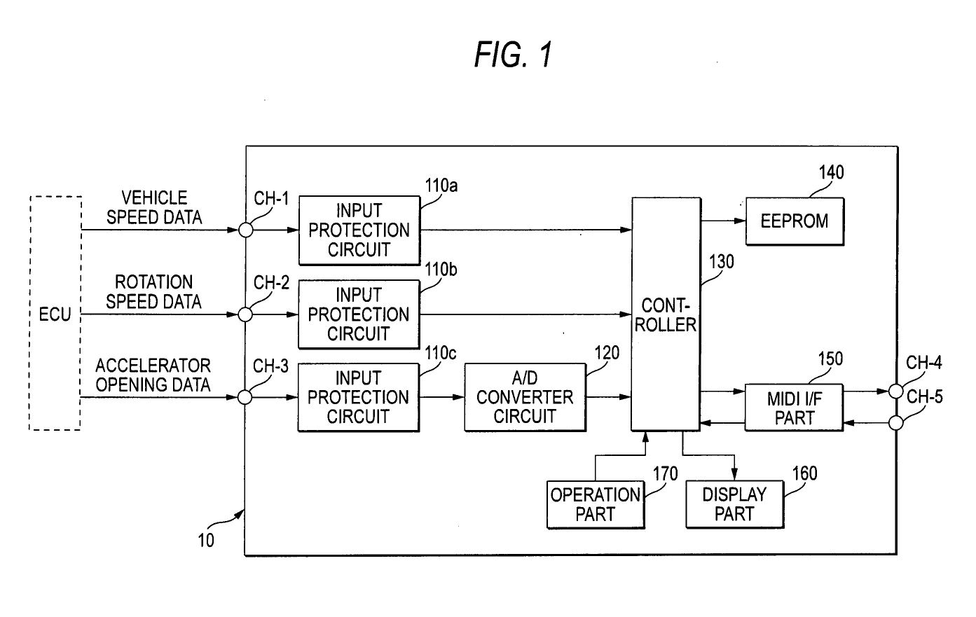

FIG. 1 is a block diagram showing a configuration example of a data converting device 10 according to an embodiment of the invention. While not shown in detail in FIG. 1, the data converting device 10 is mounted on a vehicle such as an automobile on which an engine is mounted and which automotive by way of the engine and connected to an ECU for performing driving control of the engine.

To be more precise, the data converting device 10 is connected to the ECU via three input terminals CH-1, CH-2 and CH-3. Vehicle speed data, rotation speed data and accelerator opening data are respectively transmitted to CH-1, CH-2 and CH-3 from the ECU.

The vehicle speed data is digital data representing the travel speed (vehicle speed) of an automotive vehicle while driving the engine under the driving control of the ECU. The rotation speed data is digital data representing the number of rotations of the engine. The ECU uses a pulse counter provided inside the ECU to measure as frequency values the pulse information such as the vehicle speed and rotation speed and outputs the digital data representing the frequency values as the vehicle speed data and the rotation speed data. Further, in case the data outputted from the ECU is analog data such as rectangular wave data, the data may be measured as a frequency value on a pulse counter provided inside a controller 130.

The accelerator opening data represents the stepping amount of an accelerator plate as an operation pedal for Instructing an increase/decrease In the travel speed to the ECU. The ECU outputs as the accelerator opening data an analog signal indicating a voltage value corresponding to the stepping amount of the accelerator plate.

As shown in FIG. 1, the input channel CH-1 is connected to the controller 130 via an Input protecting circuit 110a. Similarly, the Input channel CH-2 is connected to the controller 130 via an input protecting circuit 110b.

The Input channel CH-3 is connected to the controller 130 via an input protecting circuit 110c and an A/D converter circuit 120. The reason only the input channel CH-3 is connected to the controller 130 via the input protecting circuit 110c as well as the A/D converter circuit 120 is because the accelerator opening data inputted from the ECU to the Input channel CH-3 is an analog signal. In case accelerator opening data in digital format is transmitted from the ECU, the A/D converter circuit 120 is not required. In the description that follows, each of the three input protecting circuits is represented as the “input protecting circuit 110” when they need not be discriminated from each other.

The Input protecting circuit 110 includes for example a fuse and protects the A/D converter 120 and the controller 130 from overvoltage. In case the ECU performs some kind of output restriction to prevent an overvoltage from being applied to each input terminal of the data converting device 10, the input protecting circuit 110 is not always mandatory.

The controller 130 is for example a CPU (Central Processing Unit) and executes processing specific to the inventive data converting device by reading a control program stored in an EEPROM 140 into a RAM (Random Access Memory) (not shown) and executing the same.

To be more precise, the controller 130 operating in accordance with the control program converts each of the vehicle speed data, rotation speed data and accelerator opening data transmitted from the ECU via the Input channels to MIDI format data and outputs the resulting data to a MIDI interface part 150.

The MIDI interface (I/F in FIG. 1) part 150 generates a MIDI signal corresponding to the data transmitted from the controller 130 and outputs the MIDI signal via an output channel CH-4 as well as generates data corresponding to the MIDI signal inputted via an input channel CH-5 and transmits the resulting data to the controller 130. The data inputted to the MIDI interface part 150 via the input channel CH-5 and transmitted from the MIDI interface part 150 to the controller 130 is mixed by the controller 130 with the data obtained by converting the vehicle speed data, rotation speed data and accelerator opening data into the MIDI format and the mixed data is outputted to the MIDI interface part 150.

Also, a display part 160 for displaying a message indicating the operating state of the data converting device 10 and an operation part 170 as an input device for inputting various operating instructions to the data converting device 10 are connected to the controller 130.

This is the end of description of the hardware configuration of the data converting device 10.

With such a configuration, according to the data converting device 10, vehicle driving information such as the vehicle speed data, rotation speed data and accelerator opening data transmitted from the ECU is converted into MIDI format data and a MIDI signal corresponding to such data is outputted from the MIDI interface part 150. The MIDI format is a de facto standard for data format in music communications. A variety of electronic devices including a MIDI interface such as effectors and electronic musical Instruments and MIDI-ready sound source chips are available on the market. The MIDI format will be described.

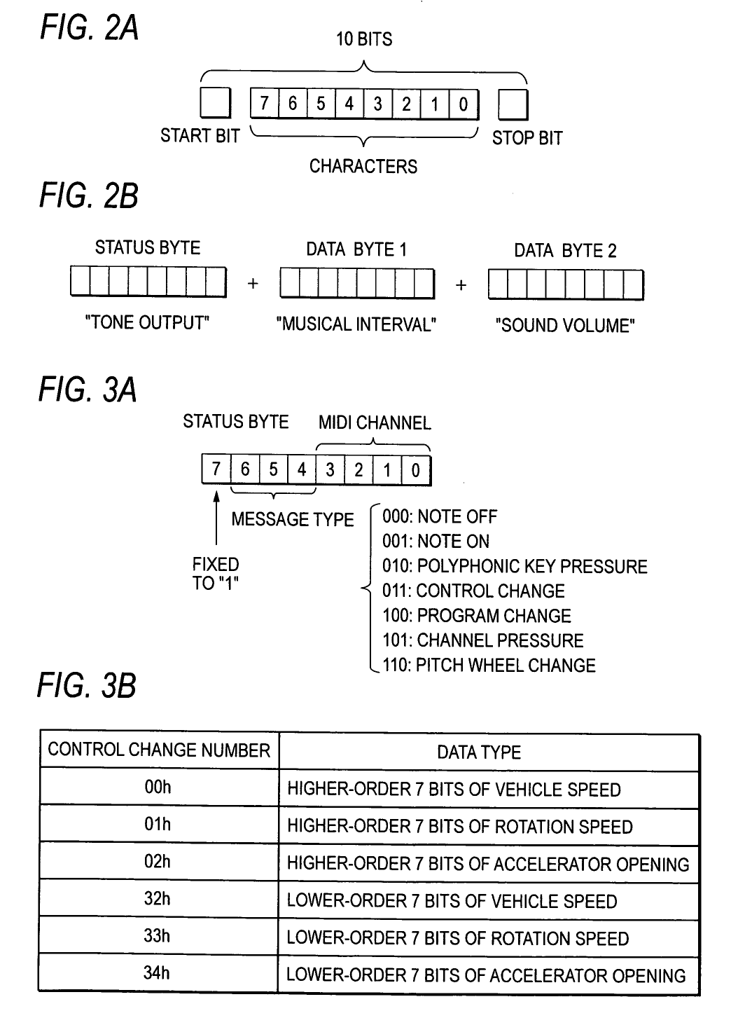

In MIDI, as shown in FIG. 2A, 8-bit data called characters to which a single-bit start bit and stop bit are added to the head and tail thereof is subjected to serial communications at a modulating/demodulating speed of 31.25[kbaud] to provide music communications. To instruct “output of a certain tone (‘C’)” to a musical instrument, three characters, a status byte indicating the “tone output”, data byte indicating the “musical interval” and data byte indicating the “sound volume” are necessary, as shown in FIG. 2B.

Total seven types of status byte shown in FIG. 3A are provided. For example, “note on” is a channel message instructing “tone output and “note off” is a channel message instructing “silencing”.

In this embodiment, control change shown in FIG. 3B is used to convert vehicle driving information. To be more precise, in this embodiment, each of the vehicle speed, rotation speed and accelerator opening is represented with an accuracy of 14 bits. For example, the control change representing the higher-order 7 bits of a vehicle speed is assigned “00h” (“h” at the end means that the preceding numerical value is hexadecimal) as a control change number. The control change representing the lower-order 7 bits of a vehicle speed is assigned “32h” as a control change number (refer to FIG. 3B).

In other words, in this embodiment, the controller 130 operating in accordance with the control program generates a single character byte representing the control change and total two data bytes representing the higher-order 7 bits and lower-order 7 bits of each of the vehicle speed data, rotation speed data and accelerator opening data transmitted from the ECU in order to convert vehicle driving information to the MIDI format. The reason each of the vehicle speed, rotation speed and accelerator opening is represented with an accuracy of 14 bits in this embodiment is because the 7-bit accuracy as a general data accuracy in MIDI is too coarse especially for a vehicle speed or a rotation speed to be properly represented. The recording timing (time resolution) of MIDI data should be minute enough to fall below the transfer rate of MIDI and the data should include full Information.

In this way, with the data converting device 10 according to this embodiment, vehicle driving information transmitted from the ECU is converted to the MIDI format as a de facto standard for data format in the music industry or music communications. This makes it possible to directly use such vehicle driving information as control parameters for effecters, electronic musical instruments and sound source chips. Software products are widely available for diversion or conversion of data to another format, which facilitates such diversion or conversion.

Recording or reproduction of MIDI format data requires no special-purpose machines but may be appropriately carried out by using for example a personal computer (PC) and a MIDI interface. Software products available as freeware for recording/reproducing the data on the persona computer may be comfortably used. This makes it possible to use a low-cost device for recording/reproduction of vehicle driving Information.

As described above, with the data converting device 10 according to this embodiment, it is possible to improve the ease-of-use of vehicle driving information transmitted from the ECU. Specific examples of use of the vehicle driving Information will be described.

### (B: Example of Use of Vehicle Driving Information in Midi Format)

In recent years, it has been proposed to reproduce an engine sound collected in the engine room of a traveling vehicle by using a car audio system for additional sense of realism. By using the data converting device 10 according to this embodiment, it is possible to process thus reproduced engine sound in various ways. The three use aspects will be discussed.

In the first aspect, an engine sound collected in an engine room is amplified at the same magnification as the accelerator opening and the amplified sound is outputted to a car audio system. In case an accelerator is not depressed, the magnification of amplification is set to 0 percent (no engine sound is outputted), and in case the accelerator is fully depressed, the magnification of amplification is set to 100 percent (the same sound pressure as the sound collected in the engine room) in the reproduction of the engine sound. The engine sound may be amplified by inputting MIDI data representing the collected engine sound to the data converting device 10 via the Input channel CH-5 of the MIDI interface part 150 and instructing the controller 130 of the data converting device 10 to amplify the engine sound.

In the second aspect, a frequency band is filtered in accordance with a rotation speed. To be more precise, an engine sound collected inside an engine room is subjected to signal processing and is divided into multiple frequency bands each of which includes a predetermined bandwidth. A specific rotation speed is previously associated with the center frequency of each frequency band. Only a band component having a center frequency corresponding to the rotation speed transmitted from the ECU is reproduced and outputted. Such filtering processing may be performed by the controller 130 of the data converting device 10, same as amplification of an engine sound corresponding to the accelerator opening.

In the third aspect, vehicle driving information is recorded in MIDI format on a traveling vehicle. Simulated reproduction of an engine sound is made using a device for synthesizing an engine sound and the recorded vehicle driving information. To be more precise, while the engine sound collected in an engine room is processed in accordance with the vehicle driving information in the first and second aspects, the engine sound synthesized by the synthesizing device is processed in accordance with the vehicle driving information recorded on a traveling vehicle before it is reproduced in the third aspect.

With such simulated reproduction of a traveling vehicle sound made available, it is expected to use this feature in the design of a vehicle or an engine and enhance the sense of realism by adding the simulated reproduction feature to a simulator or a game offering simulated vehicle driving experiences. Simulated reproduction of a traveling vehicle sound may be used in inspection of the vehicle to check for an unusual sound attributable to a fault without actually driving the target vehicle.

In this embodiment, the vehicle driving Information is converted into the MIDI format. However, this invention is not limited to the MIDI format. This Invention can be applied to other music performance formats, such as SMAF (Synthetic music Mobile Application Format) and MML (Music Macro Language).

What is claimed is:

1. A data converting device, comprising:
a first receiving section which receives vehicle driving data of a vehicle from an engine control unit for performing driving control of an engine mounted on the vehicle; and
a control section which converts the vehicle driving data into a music performance format, and outputs the converted data.

2. The data converting device according to claim 1, wherein the vehicle driving data includes at least one of vehicle speed data, rotation speed data and accelerator opening data;
wherein the vehicle speed data represents a travel speed of the vehicle;
wherein the rotation speed data represents a rotation speed of the engine; and
wherein the accelerator opening data represents a stepping amount of an accelerator plate for instructing an increase/decrease in the travel speed.

3. The data converting device according to claim 1, wherein the music performance format is a MIDI (Musical Instrument Digital Interface) format; and
wherein the control section converts the vehicle driving data into the MIDI format in which a control change number corresponding to the type of the vehicle driving data is assigned.

4. The data converting device according to claim 1, further comprising:
a second receiving section which receives sound data,
wherein the control section process the sound data with the converted data in the MIDI format, and outputs the processed data.

5. The data converting device according to claim 4, wherein the sound data is MIDI format data; and
wherein the control section mixes the MIDI format data and the converted data in the MIDI format, and outputs the mixed data.
